(19) United States
(12) Patent Application Publication
(10) Pub. No.: US 2015/0098259 A1
(43) Pub. Date: Apr. 9, 2015

(54) POWER CONVERTER, METHOD OF POWER CONVERSION, AND SWITCHING DEVICE

(71) Applicant: General Electric Company, Schenectady, NY (US)

(72) Inventors: Joseph Darryl Michael, Schenectady, NY (US); Timothy John Sommerer, Charlton, NY (US)

(73) Assignee: General Electric Company, Schenectady, NY (US)

(21) Appl. No.: 14/048,334

(22) Filed: Oct. 8, 2013

(51) Int. Cl. H02M 1/00; H01J 17/40

(52) U.S. Cl. CPC H02M 1/0061; H01J 17/40
USPC 363/111; 313/153

(57) ABSTRACT

A power converter including at least one switching device is presented. The power converter is configured to convert an input parameter to an output parameter by periodically activating and deactivating the switching device. The switching device includes: (i) a chamber including an ionizable gas; (ii) a cathode and an anode defining a discharge gap disposed in the chamber; (iii) a magnet assembly configured to generate a first magnetic field such that a plasma is maintained in the discharge gap; and (iv) an electromagnet configured to generate, in response to a deactivation signal, a second magnetic field such that at least a portion of the plasma in the discharge gap is disrupted to deactivate the switching device. A method of power conversion and a switching device are also presented.

### BACKGROUND OF THE INVENTION

The invention relates generally to power converters with gas switching devices. Particularly, the invention relates to power converters with gas switching devices, suitable for use in high-voltage power conversion applications.

Semiconductor switches are widely used in high-voltage power conversion systems because of their reliability and long life. However, the open-circuit standoff voltage of each semiconductor switch is relatively low (for example, about 10 kV), such that many semiconductor switches have to be stacked together in series to handle the high voltages (300-1000 kV). Further, the cost and complexity of the high-voltage power conversion systems employing semiconductors switches may be undesirably high.

Gas switches can stand off higher voltages for example, greater than 100 kV. However, gas switches are not widely used, because their reliability and life are not sufficient for use in electric grid applications. In conventional gas switches a control grid may be used to open the gas switches, which may pose a number of technical challenges. Further, the conventional gas switches may not have the desired switching speeds required for high-voltage power conversion systems.

Accordingly, there is a need for improved gas switch configurations. Further, it may be desirable to have high-voltage power converters with improved gas switch configurations.

### BRIEF DESCRIPTION OF THE INVENTION

One embodiment is directed to a power converter including at least one switching device. The power converter is configured to convert an input parameter to an output parameter by periodically activating and deactivating the switching device. The switching device includes:

(i) a chamber comprising an ionizable gas;

(ii) a cathode and an anode defining a discharge gap disposed in the chamber;

(iii) a magnet assembly configured to generate a first magnetic field such that a plasma is maintained in the discharge gap; and

(iv) an electromagnet configured to generate, in response to a deactivation signal, a second magnetic field such that at least a portion of the plasma in the discharge gap is disrupted to deactivate the switching device.

Another embodiment is directed to a method for power conversion. The method includes:

(I) providing a power converter comprising at least one switching device, wherein the switching device comprises:
(i) a chamber comprising an ionizable gas;
(ii) a cathode and an anode defining a discharge gap disposed in the chamber;
(iii) a switching electrode disposed between the cathode and anode;
(iv) a magnet assembly configured to generate a first magnetic field such that a plasma is maintained in the discharge gap; and
(v) an electromagnet;

(II) generating an electric field and a first magnetic field in the discharge gap to initiate and maintain a plasma in the discharge gap;

(III) applying an activation signal to the switching electrode to initiate a plasma current flow from the cathode to the anode, and to activate the switching device;

(IV) applying a deactivation signal to the electromagnet to generate a second magnetic field such that at least a portion of the plasma in the discharge gap is disrupted to deactivate the switching device; and

(V) converting an input parameter to an output parameter in the power converter by periodically activating and deactivating the switching device.

Another embodiment is directed to a switching device. The switching device includes:

(i) a chamber comprising an ionizable gas;

(ii) a cathode and an anode defining a discharge gap disposed in the chamber;

(iii) a first electromagnetic coil configured to generate a first magnetic field such that a plasma is maintained in the discharge gap; and

(iv) a second electromagnetic coil configured to generate, in response to a deactivation signal, a second magnetic field such that at least a portion of the plasma in the discharge gap is disrupted to deactivate the switching device;

wherein the first electromagnetic coil and the second electromagnetic coil are configured in an arrangement such that an electric current received at the second coil has a direction opposite to that of an electric current received at the first coil.

### DRAWINGS

These and other features, aspects, and advantages of the present invention will become better understood when the following detailed description is read with reference to the accompanying drawings, in which like characters represent like parts throughout the drawings, wherein:

FIG. 1 illustrates a power converter in accordance with some embodiments of the invention;

FIG. 2 illustrates a switching device in accordance with some embodiments of the invention;

FIG. 3 illustrates an electromagnet configuration in accordance with some embodiments of the invention;

FIG. 4 illustrates an electromagnet configuration in accordance with some embodiments of the invention;

FIG. 5 illustrates a top-view of a switching device in accordance with some embodiments of the invention;

FIG. 6 illustrates a switching device in accordance with some embodiments of the invention;

FIG. 7 illustrates a switching device in accordance with some embodiments of the invention; and

FIG. 8 illustrates a flow-chart for a power conversion method in accordance with some embodiments of the invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill, having the benefit of this disclosure.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

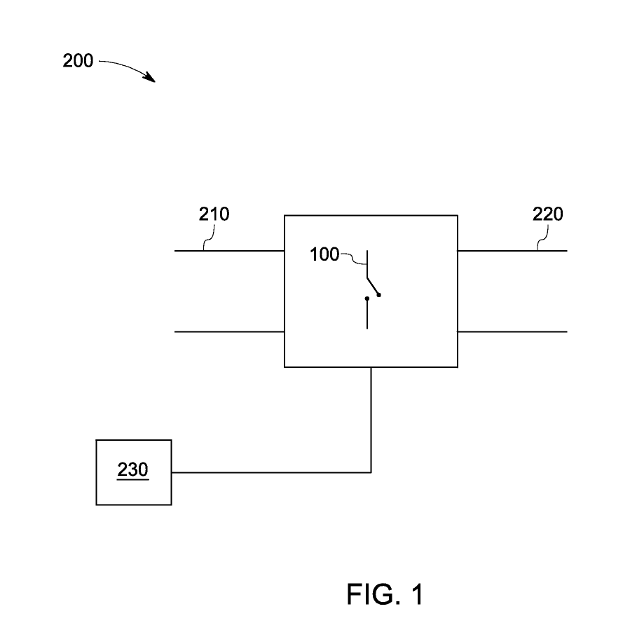

As discussed in detail below, some embodiments of the invention are directed to a power converter including at least one switching device. FIG. 1 schematically represents a power converter 200 including a switching device 100, as per one embodiment of the invention. In FIG. 1, an electric current flows from through the power converter, for example, from a source to a load. The power converter 200 is configured to convert an input parameter 210 of the current to an output parameter 220 of the current, by periodically activating and deactivating the switching device 100.

The term “power converter” as used herein refers to a device configured to convert electrical energy from one form to another (for example, alternating current (AC) to direct current (DC), or vice versa); change the voltage of the input; change the frequency of the input; or combinations thereof. Similarly, the term “power conversion” refers to converting electrical energy from one form to another (for example, alternating current (AC) to direct current (DC), or vice versa); changing the voltage; changing the frequency; or combinations thereof.

A power converter may be further classified depending on whether the input and the output are AC or DC. Thus, by way of example, the input may be DC and the power converter may be configured to convert DC to AC (in this case, the power converter may be referred to as an inverter); or vary the voltage of the DC to DC (in this case, the power converter may be referred to as a voltage stabilizer). Similarly, the input may be AC and the power converter may be configured to convert AC to DC (in this case, the power converter may be referred to as a rectifier) or vary the voltage of the AC to AC (in this case, the power converter may be referred to as a voltage regulator).

The input parameter 210 and the output parameter 220 may be independently selected from the group consisting of alternating current (AC) voltage, AC current, direct current (DC) voltage, and DC current. In some embodiments, the input parameter may be AC and the output parameter may be DC, or, alternatively, the input parameter may be DC and the output parameter may be AC. In some other embodiments, the input parameter may be a DC voltage and the output parameter may be a DC voltage greater than the input voltage (in such instances, the power converter may be also referred to as a boost converter or a step-up converter).

In certain embodiments, as described later, the power converter 200 may be employed in a high voltage direct current (HVDC) transmission system, and in such instances, the input parameter 210 may be a high voltage alternating current and the output parameter 220 may be a high voltage direct current, or vice versa. The power converter 200 in such instances may be capable of functioning as a voltage source converter (VSC), as the switching devices can be turned on and off.

As noted, the power converter 200 is configured to convert an input parameter (for example, AC) to an input parameter (for example, DC) by periodically activating and deactivating the switching device. The term “periodic” or “periodically” as used herein refers to activation and deactivation of the switching device at regular intervals of time depending on the desired output parameter. This is in contrast to circuit breakers, wherein the switch is deactivated only when a fault condition is detected.

The time interval for the activation/deactivation of the switching device may be predetermined in some embodiments, based on the desired output parameter. By way of example, the time interval may be determined based on the desired frequency of AC in the case of DC to AC conversion, or on the desired DC voltage in case of DC to DC conversion. In some other embodiments, the time interval for the activation/deactivation of the switching device may be varied during the operation of the power converter depending on the desired output parameter.

Referring again to FIG. 1, the power converter 200 is configured to allow flow of electric current, for example, from a source to a load (not shown), via at least one switching device 100. When the switching device 100 is activated (or closed), a current flow through the switching device 100. Conversely, when the switching device 100 is deactivated (or open), a current does not flow through the switching device 100. Thus, by periodically activating and deactivating the switching device 100, an input parameter 210 of the electric current is converted to an output parameter 220 of the electric current.

Although, a single switching device 100 is illustrated in FIG. 1, the power converter 100 may include more than one switching device 100 coupled together in series and/or in parallel. For example, for converting AC to DC, or vice versa, the power converter 200 may include two or more switching devices 100 to effect the conversion. In such instances, the switching devices 100 may be activated or deactivated based on switching pattern defined by the desired output parameter 220.

The activation and deactivation of the switching device may be effected on receiving an activation or deactivation signal from a controller, in some embodiments. FIG. 1 further illustrates the power converter 200 including a controller 230 electrically coupled to the switching device. As will be apparent to one of ordinary skill in the art, if a plurality of switching devices are present, the controller 230 may include multiple output terminals electrically coupled to the switching devices, thereby providing a plurality of activation and deactivation signals based on the desired switching pattern.

The controller 230 may be configured to receive one or more inputs, such as, voltage reference, output sensed voltage, current, or combinations thereof. Based on the controller logic, the controller 230 may generate the required gating pulses in a sequence, thus defining the switching pattern. Suitable non-limiting examples of the controller 230 may include a pulse width modulation (PWM) controller, a sinusoidal PWM controller, or a space vector modulation controller.

The term “switching device” as used herein refers to a device in which a current flows from one electrode to the other via a discharge gap when the switching device is closed, and no current flows when the switching device is open. In particular embodiments, the switching device is a “cold-cathode switching device”. The term “cold-cathode switching device” as used herein refers to a switching device including a cathode that operates in a cold-cathode operation mode. In a cold-cathode operation mode, electrons are emitted from the cathode surface in response to the impinging ions (“secondary electron emission”) at the cathode surface.

Secondary electron emission is distinct from other electron emission and plasma maintenance mechanisms such as thermionic emission (where the cathode is hot enough that electrons evaporate, and no ion impingement is required); field emission (where very strong electric fields on order 10⁷ V/cm at the cathode surface are able to pull electrons over the confining electrostatic potential of the surface); thermal-field emission (a synergistic combination of the previous two processes); or photoemission (where an impinging photon ejects an electron from the surface). As is generally known, in a real cathode all processes may occur simultaneously, but one process accounts for orders of magnitude more current than the others, and the name of that process is then used to describe the cathode operation and some characteristics of the overall plasma and device.

A “cold-cathode” switching device further includes a cathode material, from which the emission of electrons in response to the impact of ions from the plasma is only weakly dependent on the temperature of the material, and does not change noticeably, even when the temperature is changed so that the material melts or freezes. Thus, it will be apparent to one of ordinary skill in the art, in a cold-cathode switching device, the cathode surface temperature during operation is significantly lower than the temperature where significant thermionic electron emission occurs. The terms “cold-cathode switching device”, “switching device”, and “switch” are used herein interchangeably for the sake of brevity.

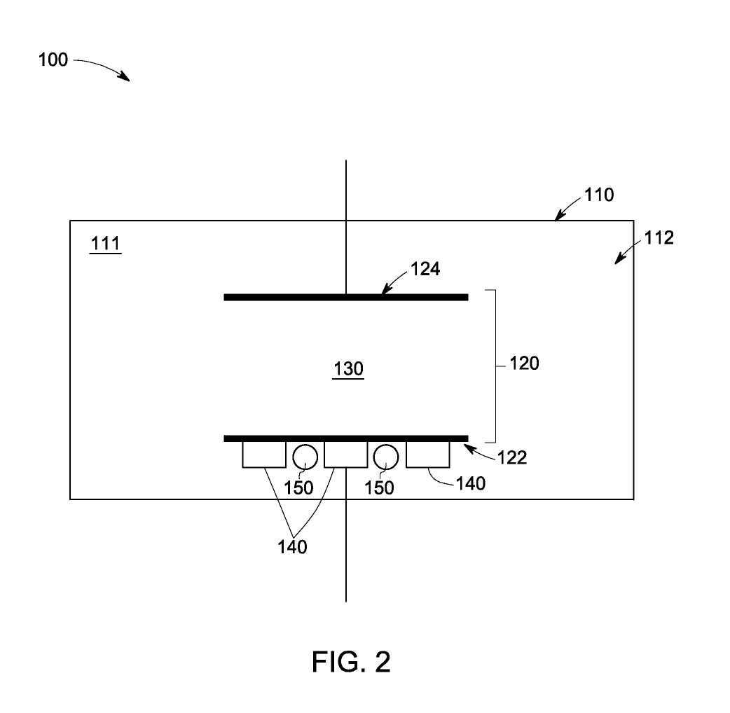

FIG. 2 schematically represents a switching device 100 as per one embodiment of the invention. As illustrated in FIG. 2, the switching device 100 includes a housing 110 defining a chamber 111. An ionizable gas 112 is disposed in the chamber 111. The switching device 100 further includes a plurality of electrodes 120 disposed in the chamber 111. Further, as illustrated in FIG. 2, the plurality of electrodes 120 includes a cathode 122 and an anode 124 defining a discharge gap 130.

In some embodiments, the area between the cathode 122 and the anode 124 is occupied by the ionizable gas, during substantially all phases of operation (closed, open, or commutating). Suitable non-limiting examples of the ionizable gas 112 include hydrogen, helium, deuterium, or combinations thereof. The ionizable gas 112 may have a pressure in a range from about 10 milli Torr to about 10 Torr. In some embodiments, the ionizable gas 112 may have a pressure in a range from about 0.1 Torr to about 5 Torr.

In an exemplary embodiment, the ionizable gas 112 is hydrogen at a pressure in a range from about 0.1 Torr to about 1 Torr, at ambient temperature. During operation, electrical current is conducted from the cathode 122 to the anode 124 through the hydrogen gas within the discharge gap 130.

An electric field may be generated in the discharge gap by applying an electrical potential across the plurality of the electrodes 120. When the switching device 100 is open (that is not conducting), the hydrogen gas insulates the anode 124 from the cathode 122. When the switching device 100 is closed (that is conducting), the hydrogen gas becomes ionized because of the electric field (that is, some portion of the hydrogen molecules are dissociated into free electrons, hydrogen molecular ions, hydrogen atoms, hydrogen atomic ions, etc.), resulting in an electrically conductive plasma. Electrical continuity is maintained between the cathode 122 and the hydrogen gas through secondary electron emission by ion impact. Energetic (for example, 100-200 electron volts (eV)) ions from the plasma are drawn to the surface of the cathode 122 by a strong electric field. The impact of the ions on the cathode 122 releases secondary electrons from the surface of the cathode 122 into the gas phase. The released secondary electrons aid in sustaining the plasma.

The switching device 100 further includes a magnet assembly 140, as illustrated in FIG. 2. The magnet assembly 140 is configured to generate a first magnetic field to alter a current carrying capacity of the switching device 100. In some embodiments, the first magnetic field in combination with the electric field aids in generating the plasma in the discharge gap 130. In certain embodiments, the first magnetic field in combination with the electric field aids in maintaining the plasma in the discharge gap 130.

The magnet assembly may be positioned at any suitable location depending on the electric field direction and the desired magnetic field direction. In certain embodiments, the magnet assembly 140 is positioned proximate to the cathode 122 relative to the anode 124, as indicated in FIG. 2. Further, the magnet assembly may include a single magnet or a plurality of magnets, configured to generate the required magnetic field.

The switching device 100 further includes an electromagnet 150, as illustrated in FIG. 2. The electromagnet 150 is configured to generate, in response to a deactivation signal, a second magnetic field such that at least a portion of the plasma in the discharge gap 130 is disrupted to deactivate the switching device 100. In some embodiments, in response to a deactivation signal, a current may be applied to the electromagnet 150 such that the second magnetic field is subtractive with respect to the first magnetic field.

This is in contrast to conventional switching devices in which the plasma is disrupted, and the switching device is opened (or deactivated) by applying an electric potential across the control grid in the opposite direction. A variable magnetic field generated using the electromagnet 150 may allow for opening of the switch independent of the operation of the switching electrode (sometimes also referred to as a control grid). Further, the switching speed may be slow in conventional switching devices. The combination of the electromagnet 150 with the magnet assembly 140, in accordance with some embodiments of the invention, may allow for faster opening of the switches, and thus faster switching times.

The electromagnet 150 may be positioned at any suitable location depending on the first magnetic field direction and the desired second magnetic field direction. In certain embodiments, the electromagnet 150 is positioned proximate to the magnet assembly 140, as indicated in FIG. 2. Further, the electromagnet 150 may include a single coil or a plurality of coils configured to generate the required second magnetic field.

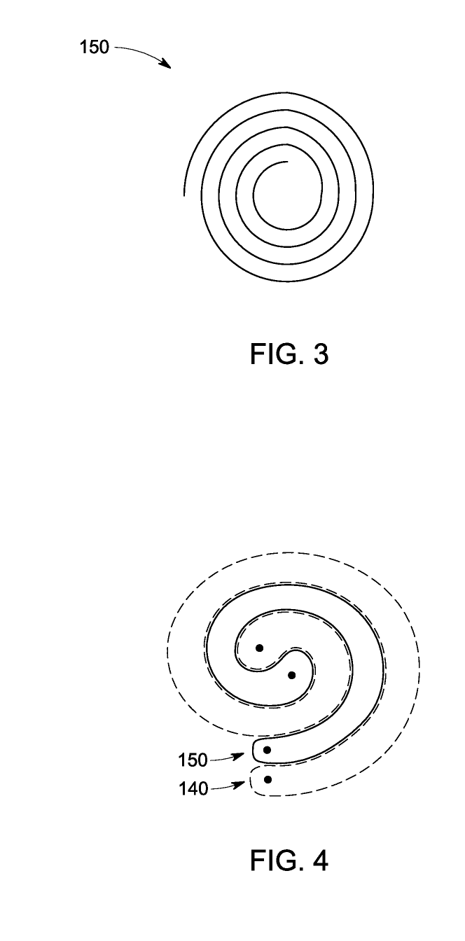

In some embodiments, the electromagnet 150 includes at least one coil arranged in a spiral configuration, a coaxial configuration, a solenoidal configuration, or combinations thereof. In some embodiments, the electromagnet 150 includes at least one coil arranged in a spiral configuration, as illustrated in FIG. 3. In some embodiments, the electromagnet 150 includes at least one coil arranged in a pancake configuration.

The magnet assembly 140 includes one or more permanent magnet(s) in some embodiments. In such instances, the electromagnet 150 may include one or more current conducting coil(s) configured to generate a second magnetic field, such that the first magnetic generated by the permanent magnet(s) is disrupted to deactivate the switching device.

In some other embodiments, the magnet assembly 140 may include an electromagnet. In such instances, the magnet assembly 140 includes a first coil and the electromagnet 150 includes a second coil. In some embodiments, the first coil and the second coil are configured in an arrangement such that an electric current received at the second coil has a direction opposite to that of an electric current received at the first coil. FIG. 4 illustrates an embodiment of the invention, including a first coil 140 and a second coil 150 arranged in a spiral configuration. In such instances, the current flow through the first coil 140 is in a direction opposite to that of the current flow in the coil 150, such that the first magnetic field and the second magnetic field are subtractive.

Further, in such instances, the first coil 140 may be configured to receive a substantially continuous electric current, such that, a first magnetic field is generated and the plasma is maintained in the discharge gap 130. The second coil 150 may be configured to receive, in response to a deactivation signal, a pulsed current in an opposite direction, such that the second magnetic field is generated to negate the first magnetic field and to disrupt at least a portion of the plasma.

In some embodiments, the electromagnet 150 may be further configured to generate a second magnetic field, such that the first magnetic field is augmented when the switching device is closed (that is conducting). Without being bound by any theory, it is believed that use of the electromagnet 150 to further augment the first magnetic field may result in improved electron confinement times. In some such instances, a current may be applied to electromagnetic coil(s) 150 in a direction such that the first magnetic field and the second magnetic field are additive. Further, in such instances, in order to disrupt the plasma and to deactivate the switching device, a current may be applied to the electromagnetic coil(s) 150 in a direction such that the first magnetic field and the second magnetic field are subtractive.

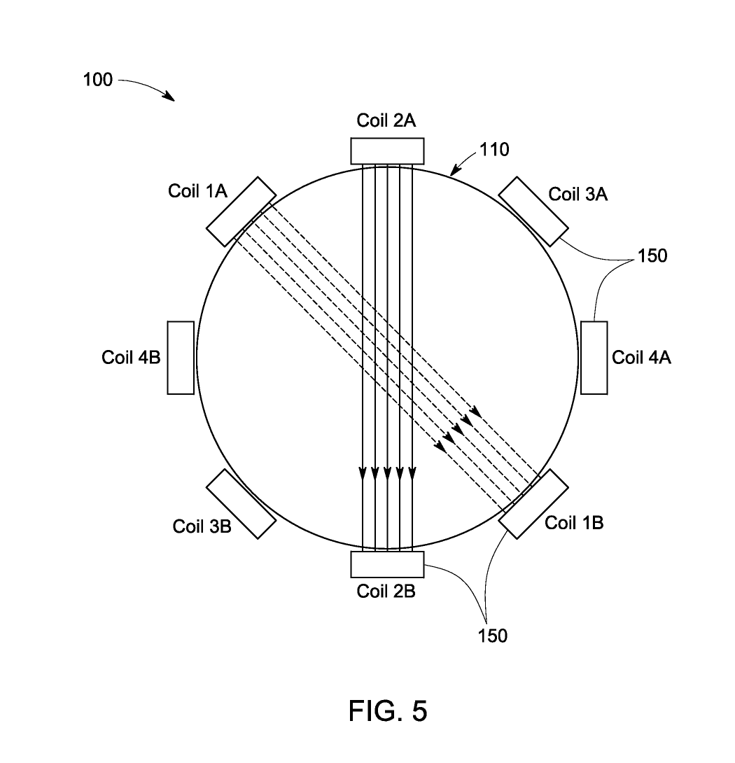

In some other instances, the electromagnet 150 may include a plurality of electromagnetic coil pairs, such that, the magnetic fields generated across the coil pairs are subtractive with the respect to the first magnetic field. FIG. 5 illustrates an embodiment of the invention, wherein a plurality of electromagnetic coil pairs are disposed proximate to an outer surface of the chamber 110 of the switching device 100. In the embodiment illustrated in FIG. 5, the plurality of electromagnetic coil pairs 1A, 1B, 2A, 2B, 3A, 3B, 4A, and 4B are configured to generate a second magnetic field that is subtractive with respect to the first magnetic field, and thereby capable of disrupting the plasma. Without being bound by any theory, it is believed that when the second magnetic field is generated, these coil pairs become energized and draw the electrons towards the chamber walls, thereby increasing the diffusion of the electrons to the walls and causing the plasma to extinguish.

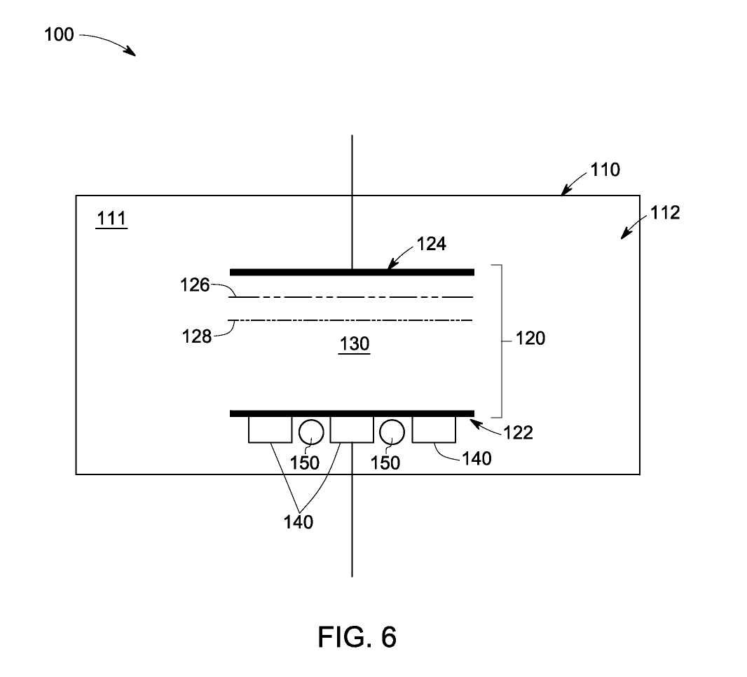

In some embodiments, the plurality of electrodes 120 may further include one or more additional electrodes. As illustrated in FIG. 6, the switching device 100 may further include a switching electrode 126 disposed between the cathode 122 and the anode 124. The switching electrode 126 is configured to periodically initiate a plasma current flow from the cathode 122 to the anode 124, in response to an activation signal to activate the switching device 100, in some embodiments.

In some embodiments, the switching electrode 126 may be further configured to open (deactivate) the switching device 100 in response to a deactivation signal. The potential of the switching electrode 126 may be changed to interrupt the flow of current between the cathode 122 and the anode 124, thereby opening the switching device 100. In such instances, the switching electrode 126 may function along with the electromagnet 150 to deactivate the switching device 100.

In some embodiments, as illustrated in FIG. 6, the switching device 100 may further include a source electrode 128 configured to provide initial ionization to close the switching device 100. Suitable non-limiting examples of the source electrode 128 include cosmic rays, ignitors, triggers, keep-alive plasmas, or combinations thereof. In particular embodiments, the source electrode 128 includes a keep-alive grid (sometimes referred to in the art as “simmer”). The keep-alive grid 128 may include a mesh or a screen of a conducting material that allows electrons and the gas ions to pass through. The keep-alive grid 128 is configured to maintain a weak ionized gas between the grid 128 and the cathode 122 to facilitate closing the switching device 100 without, for example, use of an ignitor.

In some embodiments, the switching device 100 may further include one or more additional components configured to increase the current density of the switching device 100. The current density at the cathode surface may be increased by one or more of suitable methods, such as for example, use of hollow cathodes.

The high-voltage standoff of the switching device 100 with a ‘switching’ electrode, as described herein may be determined by the geometry of the anode 124, the switching electrode 126, and the intervening volume of the ionizable gas 112. The volume between the switching electrode 126 and the cathode 122 may not affect the high-voltage-standoff properties of the switching device 100 when it is open, and may be adjusted and optimized to improve the current-carrying properties of the switching device 100 when it is closed. The presence of an intervening keep-alive grid 128 may also not affect the high-voltage standoff properties of the switching device 100.

As noted, the high voltage standoff capability of the device, when it is open, may be determined by the ionizable gas properties and the geometry of the volume that separates the voltages on the electrodes (that is, the ‘active’ portions of the electrodes). The exemplary switching device 100, as illustrated in FIGS. 2 and 6 is a plane-parallel switch. In such configurations, the cathode 122 is a substantially planar cathode and the anode 124 is a substantially planar anode. Alternatively, the switching device 100, the cathode 122, and the anode 124 may have any suitable configuration for operation as described herein.

In some embodiments, the switching device 100 may include any suitable configuration, such as, for example, a planar configuration, a crossed-field switch configuration, or combinations thereof. Various types of crossed-field switches are described in the literature, for example, in U.S. Pat. No. 5,828,176, which is incorporated herein by reference so long as not directly contradictory to the teachings described herein; and in a reference entitled “Cold-Cathode, Pulsed-Power Plasma Discharge Switch”, D. Goebel, Rev. Sci. Instrum. 67(9) September 1996 (p. 3136 et seq). Planar configurations are also generally known in the art, and are considered to be planar variants of the crossed-field switches described in the above references.

The power converter 200 in accordance with some embodiments of the invention may be useful in power transmission systems. In certain embodiments, the power converter 200 may find applications in high-voltage direct-current (HVDC) transmission systems.

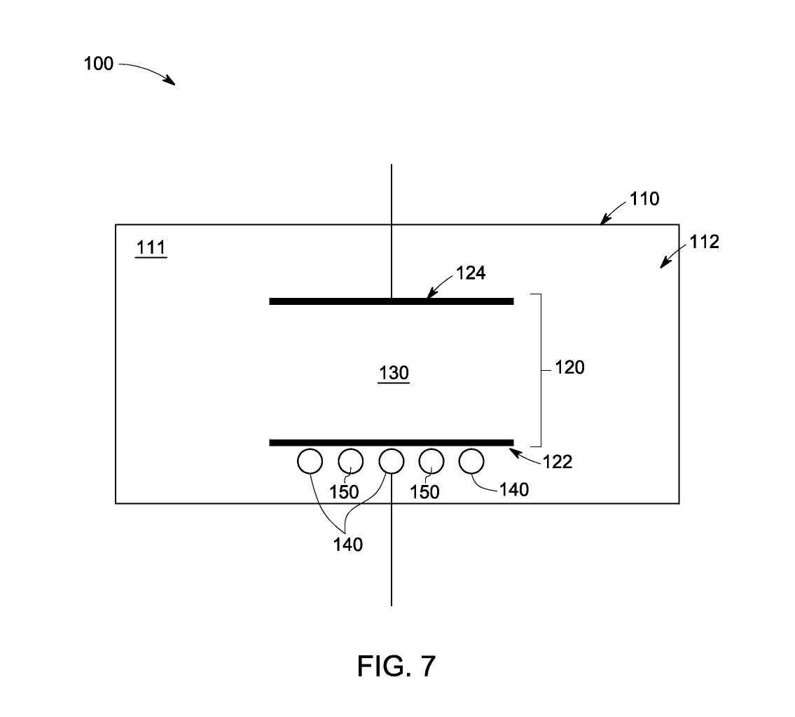

A switching device is also presented. FIG. 7 schematically represents a switching device 100 as per one embodiment of the invention. As illustrated in FIG. 7, the switching device 100 includes a housing 110 defining a chamber 111. An ionizable gas 112 is disposed in the chamber 111. The switching device 100 further includes a plurality of electrodes 120 disposed in the chamber 111. Further, as illustrated in FIG. 7, the plurality of electrodes 120 include a cathode 122 and an anode 124 defining a discharge gap 130. In some such embodiments, the cathode includes a substantially planar cathode and the anode includes a substantially planar anode.

The switching device 100 further includes a first electromagnetic coil 140 configured to generate a first magnetic field such that a plasma is maintained in the discharge gap 130, as indicated in FIG. 7. The switching device furthermore includes a second electromagnetic coil 150 configured to generate, in response to a deactivation signal, a second magnetic field such that at least a portion of the plasma in the discharge gap 130 is disrupted to deactivate the switching device 100, as indicated in FIG. 7. The first electromagnetic coil 140 and the second electromagnetic coil 150 are configured in an arrangement such that an electric current received at the second coil 150 has a direction opposite to that of an electric current received at the first coil 140.

In some such embodiments, the first coil 140 may be configured to receive a substantially continuous electric current, such that, a first magnetic field is generated and the plasma is maintained in the discharge gap 130. The second coil 150 may be configured to receive a pulsed current in an opposite direction, such that, in response to a deactivation signal, the second magnetic field is generated to negate the first magnetic field and to disrupt at least a portion of the plasma.

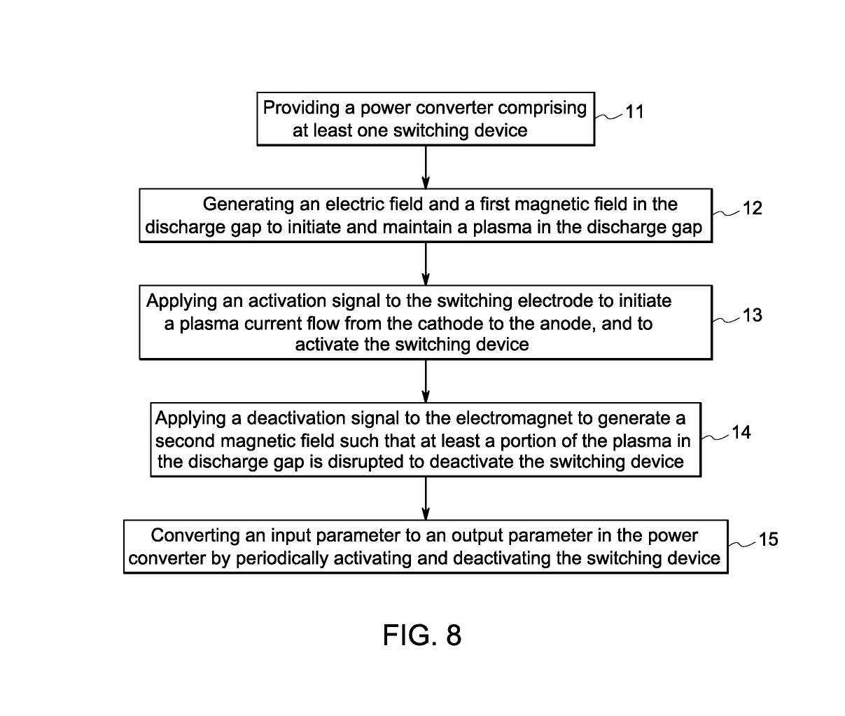

A method for power conversion is presented. The method is further illustrated with respect to FIGS. 1, 6 and 8. The method includes at step 11, providing a power converter 200 including at least one switching device 100. As described in detail earlier, and shown in FIGS. 1 and 6, the switching device 100 includes a housing 110 defining a chamber 111. An ionizable gas 112 is disposed in the chamber 111. The switching device 100 further includes a plurality of electrodes 120 disposed in the chamber 111. Further, as shown in FIGS. 1 and 6, the plurality of electrodes 120 include a cathode 122 and an anode 124 defining a discharge gap 130.

A switching electrode 126 is further disposed between the cathode 122 and anode 124, in some embodiments, as shown in FIG. 6. The switching device 100 further includes a magnet assembly 140. The magnet assembly 140 is configured to generate a first magnetic field such that a plasma is maintained in the discharge gap 130. The switching device furthermore includes an electromagnet 150, as shown in FIGS. 1 and 6.

The method further includes, at step 12, generating an electric field in the discharge gap by applying an electric potential across the plurality of electrodes 120. As mentioned earlier, when the switching device 100 is open (that is not conducting), the ionizable gas insulates the anode 124 from the cathode 122. When the switching device 100 is closed (that is conducting), the ionizable gas becomes ionized because of the electric field (that is, some portion of the gas molecules are dissociated into free electrons, molecular ions, atoms, atomic ions, etc.), resulting in an electrically conductive plasma. Electrical continuity is maintained between the cathode 122 and the ionizable gas through secondary electron emission by ion impact. Energetic ions from the plasma are drawn to the surface of the cathode 122 by a strong electric field. The impact of the ions on the cathode 122 releases secondary electrons from the surface of the cathode 122 into the gas phase. The released secondary electrons aid in sustaining the plasma.

The magnet assembly 140 is further used to maintain the generated plasma in the discharge gap 130. In embodiments wherein the magnet assembly includes one or more permanent magnet(s), a first magnetic field may be continuously generated in the discharge gap 130, such that the plasma is maintained. In embodiments, wherein the magnet assembly includes one or more electromagnet(s), a first magnetic field may be continuously generated in the discharge gap 130 by applying a substantially continuous current to the electromagnet(s), such that the plasma is maintained.

The method further includes, at step 13, applying an activation signal to the switching electrode 126 to initiate a plasma current flow from the cathode 122 to the anode 124, and to activate the switching device 100. The activation signal may be applied by a controller 230 (shown in FIG. 1) to the switching device 100, based on a switching pattern determined by the desired output parameter. As noted earlier, in some embodiments, the power converter 200 may include a plurality of switching devices 100. In such instances, the method may include applying an activation signal to at least one switching device 100 or a plurality of switching device(s) 100 at the same time, based on the desired switching pattern.

The method further includes, at step 14, applying a deactivation signal to the electromagnet 150 to generate a second magnetic field such that at least a portion of the plasma in the discharge gap 130 is disrupted to deactivate the switching device 100. The deactivation signal may be applied by a controller 230 (shown in FIG. 1) to the switching device 100, based on a switching pattern determined by the desired output parameter. In some embodiments, the method may include applying a pulsed current to the electromagnet 150 to generate the second magnetic field. The pulsed current applied to the electromagnet may depend on the switching pattern determined by the desired output parameter.

As noted earlier, in some embodiments, the power converter 200 may include a plurality of switching devices 100. In such instances, the method may include applying a deactivation signal to a switching device 100 or a plurality of switching device(s) 100 at the same time, based on the desired switching pattern.

In some embodiments, the magnet assembly 140 may also include an electromagnet. In such instances, the magnet assembly 140 may include a first coil and the electromagnet 140 may include a second coil, and the method may include applying a current to the second coil that is opposite in direction to a current applied to the first coil.

The method further includes, at step 15, converting an input parameter 210 to an output parameter 220 in the power converter 200 by periodically activating and deactivating the switching device 100. When the switching device 100 is activated (or closed), a current flows through the switching device 100. Conversely, when the switching device 100 is deactivated (or open), a current does not flow through the switching device 100. Thus, by periodically activating and deactivating the switching device 100, an input parameter 210 of the electric current is converted to an output parameter 220 of the electric current.

The input parameter 210 and the output parameter 220 may be independently selected from the group consisting of alternating current (AC) voltage, AC current, direct current (DC) voltage, and DC current. In some embodiments, the input parameter may be AC and the output parameter may be DC, or, alternatively, the input parameter may be DC and the output parameter may be AC. In some other embodiments, the input parameter may be a DC voltage and the output parameter may be a DC voltage greater than the input voltage.

In certain embodiments, the power conversion may be effected in a high voltage direct current (HVDC) transmission system, and in such instances, the input parameter 210 may be a high voltage alternating current and the output parameter 220 may be a high voltage direct current, or vice versa.

For high-voltage switching applications, such as, HVDC terminals, and in comparison with power conveter using semiconductor switches, a power conveter and a method of power converson, in accordance with some embodiments of the invention, may be advantageous. A single gas tube switch may stand off much higher voltage, on the order of about 100 kV, versus about 10 kV for a semiconductor switch. Fewer switches may be therefore required to stand off a given voltage (e.g., 1000 kV). Further, combination of the magnet assembly with the electromagnets to deactive the switch may allow for switching off the device, and more particularly faster switching speeds.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

1. A power converter, comprising:
at least one switching device, wherein the power converter is configured to convert an input parameter to an output parameter by periodically activating and deactivating the switching device, wherein the switching device comprises:
(i) a chamber comprising an ionizable gas;
(ii) a cathode and an anode defining a discharge gap disposed in the chamber;
(iii) a magnet assembly configured to generate a first magnetic field such that a plasma is maintained in the discharge gap; and
(iv) an electromagnet configured to generate, in response to a deactivation signal, a second magnetic field such that at least a portion of the plasma in the discharge gap is disrupted to deactivate the switching device.

2. The power converter of claim 1, wherein the switching device further comprises a switching electrode disposed between the cathode and the anode, wherein the switching electrode is configured to periodically initiate a plasma current flow from the cathode to the anode, in response to an activation signal to activate the switching device.

3. The power converter of claim 2, wherein the switching device further comprise a source electrode disposed between the cathode and the switching electrode.

4. The power converter of claim 1, wherein the cathode comprises a substantially planar cathode and the anode comprises a substantially planar anode.

5. The power converter of claim 1, wherein the magnet assembly comprises a permanent magnet.

6. The power converter of claim 1, wherein the electromagnet comprises at least one coil arranged in a spiral configuration, a coaxial configuration, a selenoidal configuration, or combinations thereof.

7. The power converter of claim 1, wherein the magnet assembly comprises an electromagnet.

8. The power converter of claim 7, wherein the magnet assembly comprises a first coil and the electromagnet comprises a second coil, and wherein the first coil and the second coil are configured in an arrangement such that an electric current received at the second coil has a direction opposite to that of an electric current received at the first coil.

9. The power converter of claim 8, wherein the first coil is configured to receive a substantially continuous electric current, and the the second coil is configured to receive a pulsed electric current.

10. The power converter of claim 1, wherein the input parameter and the output parameter are independently selected from the group consisting of alternating current (AC) voltage, AC current, direct current (DC) voltage, and DC current.

11. The power conveter of claim 1, wherein the power conveter is configured to be used in a high voltage direct current (HVDC) transmission system.

12. A method for power conversion, comprising:
(I) providing a power converter comprising at least one switching device, wherein the switching device comprises:
(i) a chamber comprising an ionizable gas;
(ii) a cathode and an anode defining a discharge gap disposed in the chamber;
(iii) a switching electrode disposed between the cathode and anode;
(iv) a magnet assembly configured to generate a first magnetic field such that a plasma is maintained in the discharge gap; and
(v) an electromagnet;
(II) generating an electric field and a first magnetic field in the discharge gap to initiate and maintain a plasma in the discharge gap;
(III) applying an activation signal to the switching electrode to initiate a plasma current flow from the cathode to the anode, and to activate the switching device;
(IV) applying a deactivation signal to the electromagnet to generate a second magnetic field such that at least a portion of the plasma in the discharge gap is disrupted to deactivate the switching device; and
(V) converting an input parameter to an output parameter in the power converter by periodically activating and deactivating the switching device.

13. The method of claim 12, wherein step (IV) comprises applying a pulsed current to the electromagnet to generate the second magnetic field.

14. The method of claim 12, wherein the magnet assembly comprises a first coil and the electromagnet comprises a second coil, and the method comprises applying a current to the second coil that is opposite in direction to a current applied to the first coil.

15. The method of claim 12, wherein the cathode comprises a substantially planar cathode and the anode comprises a substantially planar anode.

16. The method of claim 12, wherein the input parameter and the output parameter are independently selected from the group consisting of alternating current (AC) voltage, AC current, direct current (DC) voltage, and DC current.

17. The method of claim 12, wherein the power conversion is effected in a high voltage direct current (HVDC) transmission system.

18. A switching device, comprising:
(i) a chamber comprising an ionizable gas;
(ii) a cathode and an anode defining a discharge gap disposed in the chamber;
(iii) a first electromagnetic coil configured to generate a first magnetic field such that a plasma is maintained in the discharge gap; and
(iv) a second electromagnetic coil configured to generate, in response to a deactivation signal, a second magnetic field such that at least a portion of the plasma in the discharge gap is disrupted to deactivate the switching device;
wherein the first electromagnetic coil and the second electromagnetic coil are configured in an arrangement such that an electric current received at the second coil has a direction opposite to that of an electric current received at the first coil.

19. The switching device of claim 18, wherein the first electromagnetic coil is configured to receive a substantially continuous electric current, and the the second electromagnetic coil is configured to receive a pulsed electric current.

20. The switching device of claim 18, wherein the cathode comprises a substantially planar cathode and the anode comprises a substantially planar anode.
